(19) United States
(12) Patent Application Publication
(10) Pub. No.: US 2002/0166242 A1
(43) Pub. Date: Nov. 14, 2002

(54) Standing spoon with an arcuate bottom

(76) Inventor: Chin-Lien Huang, Tucheng City (TW)

Correspondence Address: Jenifer C. Slinskey, Esq., Thorp Reed & Armstrong, LLP, One Oxford Centre, 14th Floor, 301 Grant St., Pittsburgh, PA, 15219, US

(21) Appl. No.: 09/853,436

(22) Filed: May 11, 2001

(51) Int. Cl. A47J 43/28

(52) U.S. Cl. 30/324; D07/653

(57) ABSTRACT

A standing spoon has a bowl and a handle extending out from an edge of the bowl. The center of gravity of the spoon is located within the enclosed volume of the bowl by adding a weight to an end face of the spoon. The bowl has an arcuate bottom face, such that after the addition of the weight, the spoon is able to stand upright by itself.

### BACKGROUND OF THE INVENTION

1. Field of the Invention

The present invention relates to a standing spoon with an arcuate bottom, and more particularly to a standing spoon that can stand upright by itself. The standing spoon has an arcuate bottom face that is provided with a weight mounted on an end face of the arcuate bottom face and a handle with appropriate length, so that with the incorporation of the weight and the handle, the center of gravity falls within the enclosed volume of the bowl of the spoon no matter how the bowl inclines.

2. Description of Related Art

A spoon normally has a bowl and a handle integrally formed with the bowl and extending out from an edge of the bowl. Because the extra weight of the handle is added to the bowl, the center of gravity of the spoon is always outside the enclosed volume of the bowl, such that the excess weight of the spoon makes the spoon cannot stand by itself. With such an arrangement, using this kind of spoon will be inconvenient. Because the center of gravity is outside the enclosed area of the bowl, the spoon cannot stand upright, the spoon usually falls into and contaminate the soup after each use, and the user will have to fish it out of the soup and replace it with a clean one. In order to avoid such inconvenience, the user will have to carefully place the spoon against the wall of the pot.

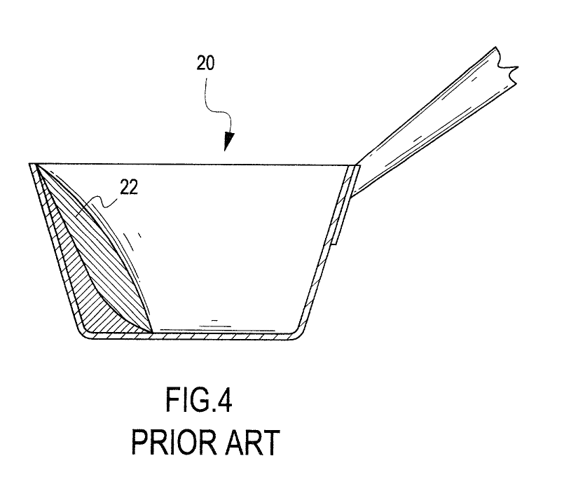

With reference to FIG. 4, a conventional standing spoon (20) is shown. The standing spoon (20) has a flat bottom (21) with a weight (22) added to a side face relative to the handle. After the addition of the weight to the side face of the standing spoon, the weight of the handle will no longer be a concern to cause a fall to the spoon, such that the spoon is able to stand upright by itself. This kind of standing spoon considers only the weight of the handle, such that the weight added to the flat bottom functions only to offset the weight of the handle. Besides, there is no limitation to the weight of the added weight, therefore, should the weight of the added weight exceed the weight of the handle, the spoon can not stand firmly and may even cause a fall. Furthermore, there is no concern to the weight of all the sides of the spoon. Therefore, when a spoon has an arcuate bottom face, the foregoing addition of the weight to the spoon can not stand the spoon upright.

To overcome the shortcomings, the present invention tends to provide an improved spoon to mitigate and obviate the aforementioned problems.

### SUMMARY OF THE MENTION

The main objective of the invention is to provide an improved spoon having a bowl and a handle integrally formed with the bowl and extending out from an edge of the bowl, wherein the bowl has a weight mounted therein so that the center of gravity falls within the enclosed volume of the bowl and the spoon of the invention is able to stand by itself.

Other objects, advantages and novel features of the invention will become more apparent from the following detailed description when taken in conjunction with the accompanying drawings.

### BRIEF DESCRIPTION OF THE DINGS

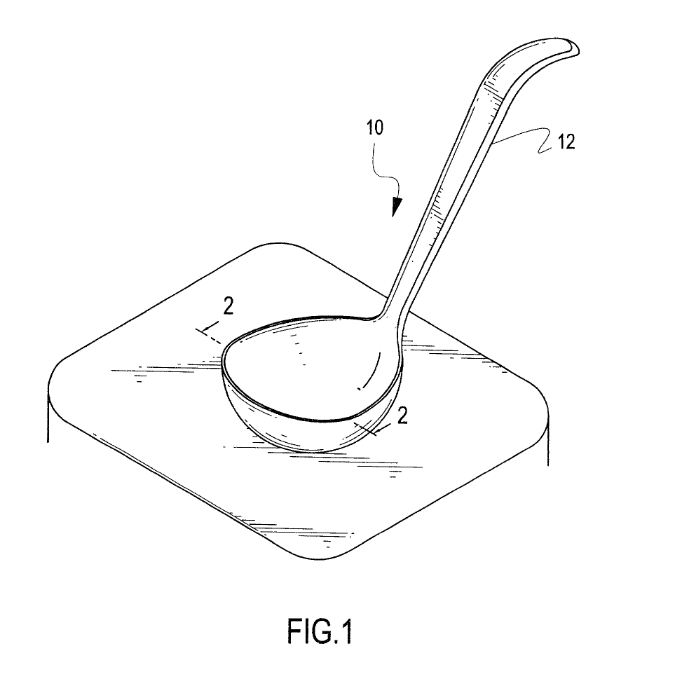

FIG. 1 is a perspective view of a standing spoon in accordance with the present invention, which is standing on a plane;

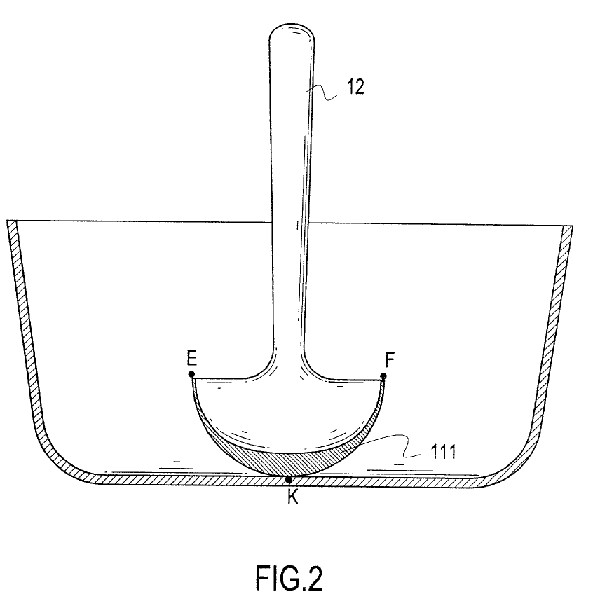

FIG. 2 is a plan view of the spoon in a container with liquid therein, wherein the spoon is in partial cross-section by taking the line 2-2 of FIG. 1;

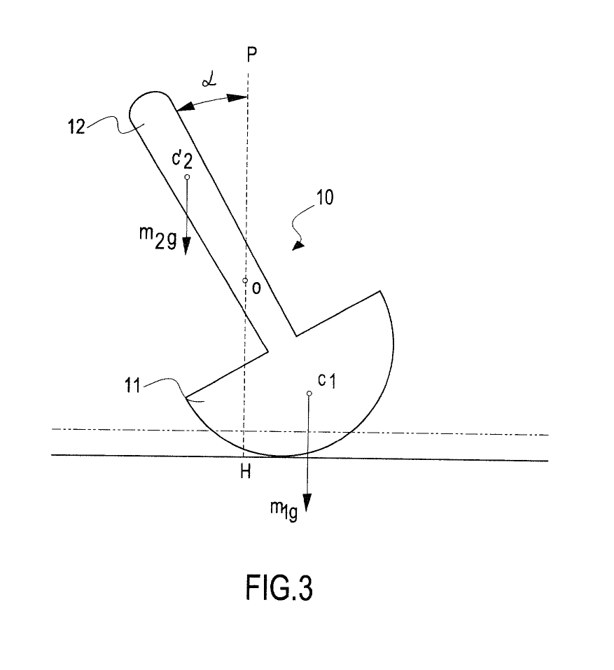

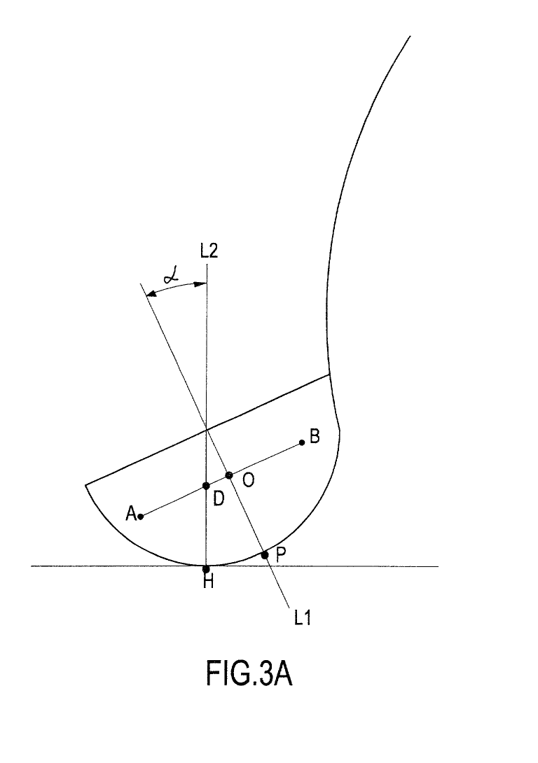

FIG. 3 is a schematic view showing the basic theory to stand the spoon of the invention;

FIG. 3A is a schematic view showing the torque change when the spoon is inclined for an angle of α; and

FIG. 4 is a side plan view of a conventional spoon with a flat bottom face.

### DETAILED DESCRIPTION OF PREFERRED EMBODIMENT

Referring to FIGS. 1 and 2, a standing spoon (10) constructed in accordance with the present invention has a bowl (11) and a handle (12) extending out from an edge of the bowl (11). FIG. 2 shows that the standing spoon has a weight (111) inserted in the front portion of an arcuate bottom face of the bowl (11) to balance the weight of the handle (12), 8=such that the center of gravity of the spoon (10) is able to be located within the enclosed volume of the bowl (11). Beside the addition of the weight (111) to the spoon (10), all sides of the bowl (11) is in static equilibrium. When the center of gravity of the spoon (10) is in the enclosed volume of the bowl (11), the spoon (10) is able to stand upright by itself. To further enhance the upright standing characteristic of the spoon of the invention, the bowl (11) of the spoon (10) has an arcuate bottom face, such that the spoon (10) is able to stand firmly on a plan. With the help of the weight (111), the spoon of the invention is able to stand upright by its own.

To further understand the principle of the invention, an example is set for explanation. With reference to FIG. 3, the spoon (10) has a center point (O), a first section (the bowl) with a weight (m1) and a second section (the handle) with a weight (m2).

The torque of the first section relative to the center point (O) can be shown as:

T₁=m1g(R−h/2)sin α

The torque of the second section relative to the center point (O) can be shown as:

T₂=−m2g(L/2−R)sin α

wherein α is the inclination angle of the spoon relative to a plan surface

L is the height of the spoon with the handle

R is the height from the bottom of the spoon to the center point (O)

h is the height from the bottom of the spoon to a rim of the bowl

$$\begin{matrix}\begin{matrix}Total torque {T}_{total} \\ would be {T}_{1} + {T}_{2}\end{matrix} = [ m1 ( R - h / 2 ) - m2 ( L / 2 - R ) ] g sin α \\ = [ ( m1 + m2 ) R - 1 / 2 ( m1h + m2L ) ] g sin α \\ = [ \underline{R - ( m1h + m2L ) / 2 ( m1 + m2 ) ] ( m1 + m2 ) g sin α}\end{matrix}$$

Suppose X=R−(m1h+m2L)/2(m1+m2)

then Tₜₒₜₐₗ=X(m1+m2)g sin α

Considering the situations of the above equations:

should X>0 and Tₜₒₜₐₗ>00 the spoon is in stability;

should X<0 and Tₜₒₜₐₗ<0, the spoon is unstable;

should X=0 and Tₜₒₜₐₗ=0 the total torque is zero (0)

According to the conclusion, the spoon is made to make the torque of m1 always bigger than that of m2 with respect to the center point O. Thus, with the weight (111) added in the bottom arcuate surface of the spoon, the spoon is able to stand upright at all times.

Further, the length of the handle affects the location of C₂ (as shown in FIG. 3), which accordingly affects the magnitude of the torque m2g, such that only has the handle a proper length, the torque m₁g is larger than that of M₂g and keeps the spoon in stability. Accordingly, the length of the handle of the invention is based on the foregoing theory to have the torque m₁g larger than the torque m₂g and the spoon is able to be in a stable situation under different situations.

With reference to FIGS. 3 and 3A, it is noted that when the spoon is placed on a surface, the spoon will incline for an angle α. The torque at point B (BD) is larger than the torque (AD) at point A, thus the point B has a downward tendency, which causes the spoon to roll to the point B. However, the rolling movement causes the point with high torque shifts to point A. After several times of shifting the point with high torque, due to the rolling friction between the spoon and the surface, the inclination angle is becoming smaller each time. According to the simulation, after careful calculation by the computer, the periphery of the bowl is designed to have numeral points each on opposite sides with respect to the center of gravity. Therefore, any inclination (unbalance) to the spoon will be overcome by the added weight to the spoon and stand upright by itself. Referring back to FIG. 2, it is noted that with the reference of points E, F, K a sectorial area (the bottom face of the spoon) is able to be determined. Therefore, based on the formula of T₁+T₂=[m1(R−h/2)−m2(L/2−R)]g sin α, when design the spoon, the length of \overline{EF} is known, then again according to the situation of T₁+T₂>0 and under the restrain of

Sin α=Sin 90=1, the spoon is able to stand under all circumstances.

Furthermore, because L, R, m₁g and m₂g are known, it is quite easy to calculate the value of h. Then, according to \overline{EF} and h, a perfect k is able to be determined and again according to the principle of defining an arc with three points, these three points E, F and K are three references for designing the curvature of a standing spoon.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A standing spoon with a bottom bowl and a handle extending out from an edge of the bowl, the improvements comprise:
a weight added to the bowl to have the center of gravity of the spoon falls within an enclosed volume of the bowl; and
the bowl having an arcuate bottom face;
whereby the spoon is able to stand upright by the help of the weight being positioned within the enclosed volume of the bowl.
